(19) United States
(12) Patent Application Publication
(10) Pub. No.: US 2016/0234587 A1
(43) Pub. Date: Aug. 11, 2016

(54) ULTRASONIC FILTER FOR MICROPHONE

(71) Applicant: Turtle Beach Corporation, Poway, CA (US)

(72) Inventors: Brian Alan Kappus, San Diego, CA (US); Elwood Grant Norris, Poway, CA (US)

(73) Assignee: Turtle Beach Corporation, Poway, CA (US)

(21) Appl. No.: 14/614,774

(22) Filed: Feb. 5, 2015

(51) Int. Cl. H04R 1/08; H04R 23/00

(52) U.S. Cl. CPC H04R 1/08; H04R 23/00; H04R 2430/00

(57) ABSTRACT

A measurement system is provided for measuring operational characteristics of ultrasonic emitters, such as their frequency response. A low pass acoustic filter is provided to filter out the ultrasound portion of a modulated ultrasonic signal emitted by an ultrasonic emitter, thereby allowing only the audio portion of the modulated ultrasonic signal to pass through to a measurement microphone. The low pass acoustic filter may include one or more layers of a thin material, such as Mylar, wherein at least one layer of the one or more layers of the thin material have a substantially non-smooth surface to prevent unwanted reflections.

### TECHNICAL FIELD

The present disclosure relates generally to parametric speakers for a variety of applications. More particularly, some embodiments relate to an ultrasonic filter for a microphone.

### BACKGROUND

Non-linear transduction results from the introduction of sufficiently intense, audio-modulated ultrasonic signals into an air column. Self-demodulation, or down-conversion, occurs along the air column resulting in the production of an audible acoustic signal. This process occurs because of the known physical principle that when two sound waves with different frequencies are radiated simultaneously in the same medium, a modulated waveform including the sum and difference of the two frequencies is produced by the non-linear (parametric) interaction of the two sound waves. When the two original sound waves are ultrasonic waves and the difference between them is selected to be an audio frequency, an audible sound can be generated by the parametric interaction.

Parametric audio reproduction systems produce sound through the heterodyning of two acoustic signals in a non-linear process that occurs in a medium such as air. The acoustic signals are typically in the ultrasound frequency range. The non-linearity of the medium results in acoustic signals produced by the medium that are the sum and difference of the acoustic signals. Thus, two ultrasound signals that are separated in frequency can result in a difference tone that is within the 20 Hz to 20,000 Hz range of human hearing.

### SUMMARY

Embodiments of the technology described herein include an ultrasonic filter for a microphone.

In accordance with one embodiment, a measurement system, comprises: a microphone; an acoustic filter disposed intermediate and substantially orthogonal to a diaphragm of the microphone and an ultrasonic emitter, the acoustic filter being configured to filter at least one ultrasound signal component from an audio modulated ultrasonic signal launched by the ultrasonic emitter such that substantially only an audio signal produced in the air between the ultrasonic emitter and the acoustic filter is transmitted to the diaphragm of the microphone; a preamplifier adapted to receive the audio signal from the microphone and prepare the audio signal for processing; and a measurement application configured to analyze the audio signal to determine a frequency response of the ultrasonic emitter.

In accordance with another embodiment, a measurement microphone system, comprises: a measurement microphone; and an acoustic low pass filter comprising at least one layer of film disposed intermediate to a diaphragm of the measurement microphone and an ultrasonic emitter, the acoustic low pass filter being configured to filter (e.g., at least 15 dB of an ultrasound signal) from an audio modulated ultrasonic signal launched by the ultrasonic emitter while allowing a portion of audio demodulated from the modulated ultrasonic signal to pass through the filter and to the diaphragm of the microphone such that the portion of the audio demodulated from the modulated ultrasonic signal that passes through the filter is detectable by the measurement microphone at a sufficient level to permit an intended measurement by a measurement device.

In accordance with still another embodiment, an ultrasonic acoustic filter, comprises: a film; and a frame configured to substantially support the film in a position intermediate to a diaphragm of a microphone and an ultrasonic emitter, the film being configured to filter (e.g., at least 15 dB of) an ultrasonic portion of a modulated ultrasonic signal launched by the ultrasonic emitter while allowing a portion of audio signal demodulated from the modulated ultrasonic signal to pass through the filter and to the diaphragm of the microphone.

Other features and aspects will become apparent from the following detailed description, taken in conjunction with the accompanying drawings, which illustrate, by way of example, the features in accordance with various embodiments. The summary is not intended to limit the scope of the technology disclosed herein, which is defined solely by the claims attached hereto.

### BRIEF DESCRIPTION OF THE DRAWINGS

The disclosed technology, in accordance with one or more various embodiments, is described in detail with reference to the accompanying figures. The drawings are provided for purposes of illustration only and merely depict typical or example embodiments. These drawings are provided to facilitate the reader's understanding of the systems and methods described herein, and shall not be considered limiting of the breadth, scope, or applicability of the various embodiments.

Some of the figures included herein illustrate various embodiments of from different viewing angles. Although the accompanying descriptive text may refer to elements depicted therein as being on the “top,” “bottom” or “side” of an apparatus, such references are merely descriptive and do not imply or require that various embodiments be implemented or used in a particular spatial orientation unless explicitly stated otherwise.

FIG. 1 is a diagram illustrating an ultrasonic sound system suitable for use with the emitter technology described herein.

FIG. 2 is a diagram illustrating another example of a signal processing system that is suitable for use with the emitter technology described herein.

FIG. 3 is a diagram illustrating an example testing system utilizing a measurement microphone and acoustic filter in accordance with one embodiment of the technology described herein.

FIG. 4A is a diagram illustrating a frontal view of an example acoustic filter in accordance with one embodiment of the technology described herein.

FIG. 4B is a diagram illustrating a cross-sectional view of an example acoustic filter in accordance with one embodiment of the technology described herein.

FIG. 5 is a diagram illustrating a side view of an example testing system showing the relative positioning of a measurement microphone and acoustic filter in accordance with one embodiment of the technology described herein.

The figures are not intended to be exhaustive or to limit various embodiments to the precise form disclosed. It should be understood that various embodiments can be practiced with modification and alteration, and that various embodiments be limited only by the claims and the equivalents thereof.

### Description

Embodiments of the systems and methods described herein provide a HyperSonic Sound (HSS) audio system or other ultrasonic audio system for a variety of different applications. Certain embodiments provide audio headphones incorporating ultrasonic emitters.

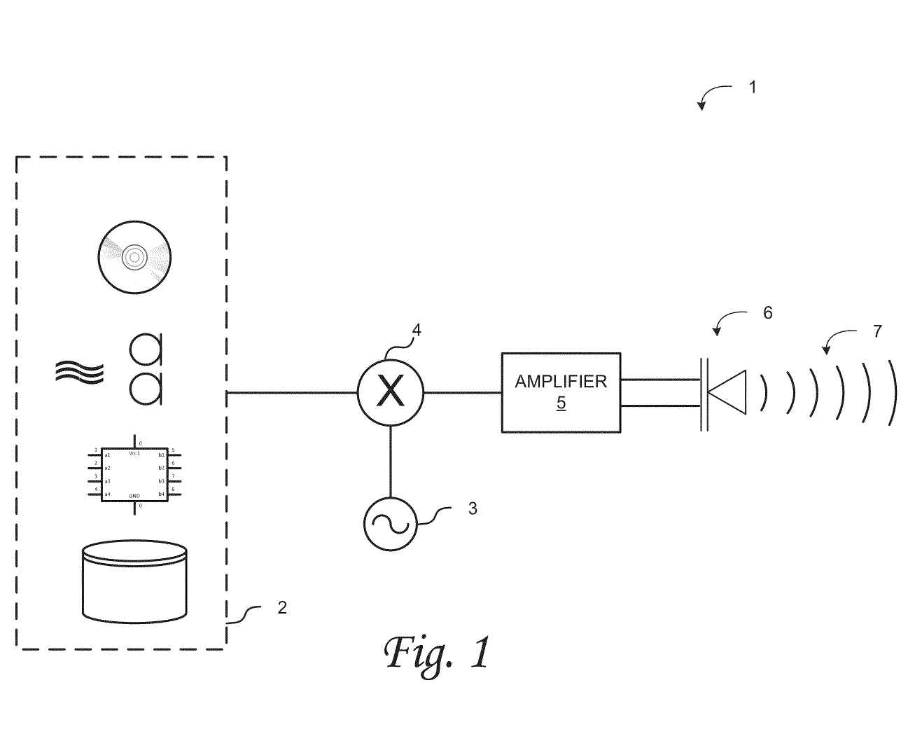

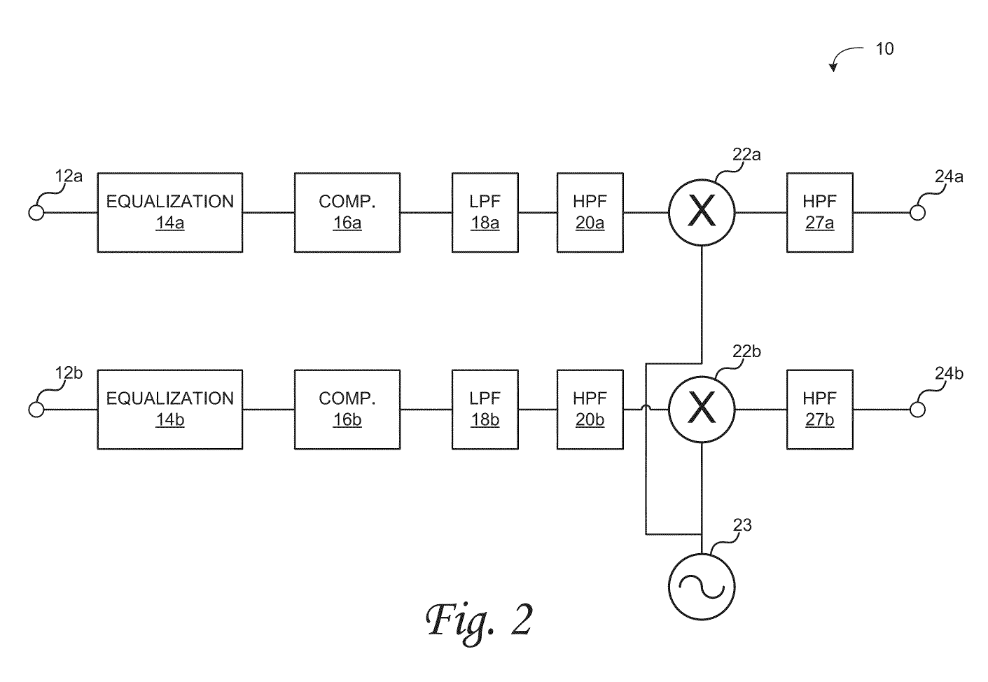

FIG. 1 is a diagram illustrating an ultrasonic sound system suitable for use in conjunction with the systems and methods described herein. In this exemplary ultrasonic audio system 1, audio content from an audio source 2, such as, for example, a microphone, memory, a data storage device, streaming media source, MP3, CD, DVD, set-top-box, or other audio source is received. The audio content may be decoded and converted from digital to analog form, depending on the source. The audio content received by the exemplary ultrasonic audio system 1 is modulated onto an ultrasonic carrier of frequency ƒ1, using a modulator. The modulator typically includes a local oscillator 3 to generate the ultrasonic carrier signal, and multiplier 4 to modulate the audio signal on the carrier signal. The resultant signal is a double- or single-sideband signal with a carrier at frequency ƒ1 and one or more side lobes. In some embodiments, the signal is a parametric ultrasonic wave or a HSS signal. In most cases, the modulation scheme used is amplitude modulation, or AM, although other modulation schemes can be used as well. Amplitude modulation can be achieved by multiplying the ultrasonic carrier by the information-carrying signal, which in this case is the audio signal. The spectrum of the modulated signal can have two sidebands, an upper and a lower side band, which are symmetric with respect to the carrier frequency, and the carrier itself.

The modulated ultrasonic signal is provided to the transducer 6, which launches the ultrasonic signal into the air creating ultrasonic wave 7. When played back through the transducer at a sufficiently high sound pressure level, due to nonlinear behavior of the air through which it is ‘played’ or transmitted, the carrier in the signal mixes with the sideband(s) to demodulate the signal and reproduce the audio content. This is sometimes referred to as self-demodulation. Thus, even for single-sideband implementations, the carrier is included with the launched signal so that self-demodulation can take place.

Although the system illustrated in FIG. 1 uses a single transducer to launch a single channel of audio content, one of ordinary skill in the art after reading this description will understand how multiple mixers, amplifiers and transducers can be used to transmit multiple channels of audio using ultrasonic carriers. The ultrasonic transducers can be mounted in any desired location depending on the application.

As described herein, various embodiments can be configured to transmit one or more channels of audio modulated onto one or more ultrasonic carriers. The transmission of audio using ultrasonic carriers can be used in a variety of different scenarios/contexts. For example, various embodiments may be utilized in or for playback of music or other audio content, implementing directed/targeted or isolated sound systems, specialized audio effects, hearing amplifiers/aids, as well as sound alteration.

Ultrasonic emitters may be tested or measured with regard to one or more performance characteristics. This can be done, for example, simply to measure the performance of the emitter relative to performance specifications, or to determine or optimize emitter performance. Microphones are often utilized in the testing and calibration of speakers and audio systems, such as home entertainment systems and the like. That is, and absent access to an anechoic chamber for testing/measuring speaker performance, users often rely on measurement microphones that can be strategically placed relative to, e.g., a speaker(s), or at some desired listening location(s). With the measurement microphones connected to a preamplifier and measurement equipment such as a spectrum analyzer, frequency response of the speaker(s) can be determined, for example.

A microphone may be thought of as a transducer. That is, a microphone generally converts acoustic energy or sound into electrical energy, which can then be amplified and sent to speakers, headphones, etc., or as described above, to a spectrum analyzer or other test equipment in the case of measurement microphones. Typically, a microphone operates by way of a diaphragm that vibrates in response to being struck by sound waves. When the diaphragm vibrates, other components in the microphone vibrate, converting mechanical movement into a corresponding varying electrical current. This electrical current can be thought of as an audio signal representing the detected sound.

Microphones typically have some directional properties. That is, their levels of sensitivity to sound may vary based on the direction of the sound source relative to the microphone orientation. Certain microphones can be referred to as directional microphones. A directional microphone is a type of microphone that can be utilized to sense or pick up audio/sound that originates in a particular area or from a specific direction. Accordingly, directional microphones have utility in applications, such as telephone headsets, where it would be desirable for only the sound of a user's voice to be sensed in order to achieve a clean/non-noisy conversation.

In contrast to directional microphones, omnidirectional microphones are capable of picking up or sensing sound from multiple directions, and accordingly, may also pick up ambient sounds. Such omnidirectional microphones can be useful in the aforementioned context of testing speakers.

However, it may be undesirable to measure the performance of an ultrasonic emitter using a conventional measurement microphone to detect the sound generated by such an ultrasonic emitter. The ultrasonic carrier and ultrasonic side bands containing the audio for reproduction, for example, can pose certain issues for measurement microphones. For instance, ultrasonic signals, which have frequencies greater than the upper limit of human hearing, i.e., 20kHz and greater, can overload a microphone's electronic or mechanical components. For example, the preamplifier used in conjunction with a measurement microphone may be pushed outside of its linear operating range by the non-linear transduction characteristics of an ultrasonic emitter. Likewise, the vibrating diaphragm may be pushed past its linear operating limits of excursion. This nonlinear response can produce ghost signals at the same frequencies as the desired measurement. This can change or even completely mask the real measurement giving incorrect data.

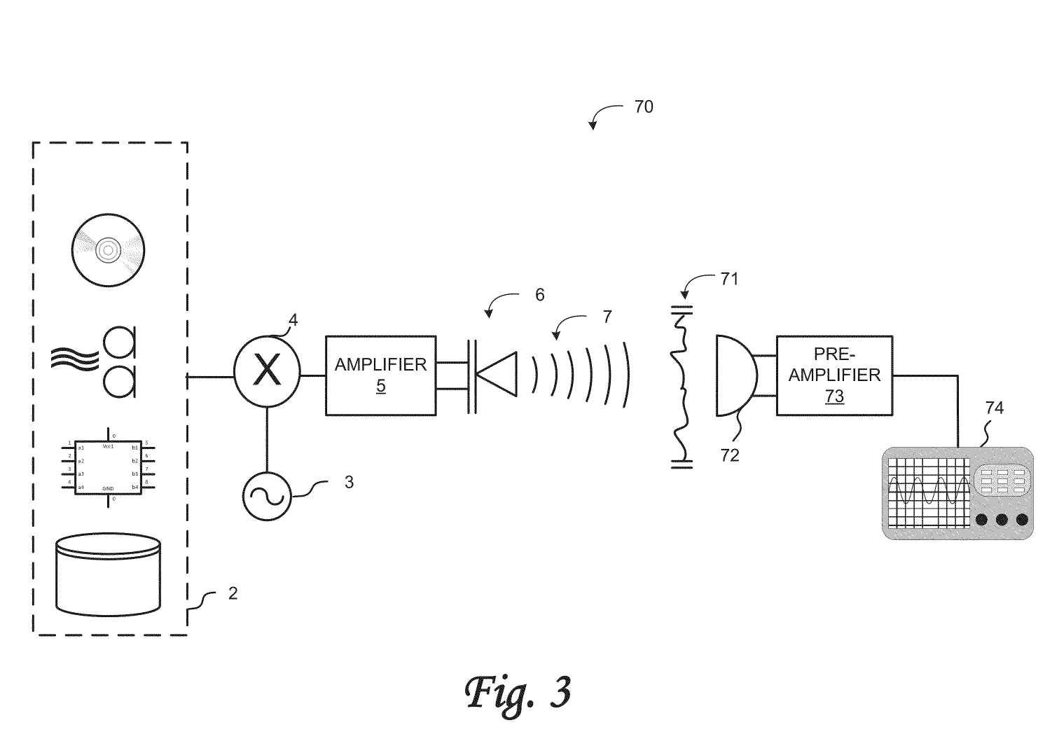

FIG. 3 illustrates a schematic diagram of an example testing system 70 utilizing a measurement microphone 72. Sound system 70 may receive audio content from an audio source 2, such as audio source 2 of FIG. 1. Again, audio source 2 may be, e.g., a microphone, memory, a data storage device, streaming media source, MP3, CD, DVD, set-top-box, or other audio source, where the audio content can be decoded and converted from digital to analog form, depending on the source. The audio content received by sound system 70 may be received via speaker cables, wirelessly, etc. The audio content may be musical content, pink noise, test tones, or other audio content.

Upon receipt of the audio signal, the audio content can be made to undergo signal processing. That is, the audio signal input into sound system 70 may be equalized to boost or suppress, as desired, one or more frequencies or frequency ranges. The audio signal may also be compressed to raise/lower certain portions of the audio signal. Filtering may also be performed to further refine the audio signal. Thereafter, the audio signal can be modulated onto an ultrasonic carrier, e.g., using a modulator that can include a local oscillator 3 to generate the ultrasonic carrier signal and a multiplier 4 to modulate the audio signal on the carrier signal.

The modulated ultrasonic signal may then be amplified using an amplifier 5. After amplification, the modulated ultrasonic signal is delivered to a driver circuit(s) (not shown), which connects to a transducer/emitter 6. As described previously, emitter 6 can be operable at ultrasonic frequencies, thereby launching ultrasonic signals into the air creating audio-modulated ultrasonic wave(s) 7. It should be noted that the ultrasonic signals/waves can be generated from any ultrasound audio source resulting in, e.g., the aforementioned parametric ultrasound or HSS audio, as well as other ultrasound schemes using various audio manipulation techniques.

Measurement microphone 72 may be an omnidirectional condenser microphone, which is a popular type of microphone used for testing/measuring audio system performance. Accordingly, measurement microphone 72 may rely on a capacitive structure, where a first capacitor plate may act as a diaphragm, which when struck by sound waves, vibrates, changing the distance between the first capacitor plate and a second capacitor plate, which in turn changes the capacitance. Voltage can be applied across the capacitive structure via a battery or external power source.

In order to allow audio signals to pass through to measurement microphone 72 without significant ultrasound (which can overload measurement microphone 72 and/or distort any resulting measurements obtained via measurement microphone 72), an acoustic filter 71 is provided. Acoustic filter 71 may be provided at some position intermediate measurement microphone 72 and emitter 6. Acoustic filter 71 may be a low pass filter configured to absorb or reflect the ultrasonic carrier signal portion (>20 kHz) and modulated sideband of the modulated ultrasonic signal output by emitter 6, while allowing the modulating audio signal (within the human hearing range, approximately 10 Hz to 20 kHz) to pass through to measurement microphone 72. It should be noted that acoustic filter 71 need not be a ‘perfect’ ultrasound filter. That is, acoustic filter 71 can simply attenuate ultrasound to a relatively higher degree than the modulating audio signal. In accordance with one embodiment, acoustic filter 71 can be configured to filter at least 15 dB of an ultrasound signal

Once the audio signal is captured by measurement microphone 72, the resulting electrical signal may be passed on to a preamplifier 73 to prepare the electrical signal for further processing, e.g., impedance conversion, additional filtering, etc. Thereafter, the electrical signal can be sent to measurement equipment 74, which may be a computer with signal analysis software running thereon, a spectrum analyzer, etc. For example, upon feeding emitter 6 a modulated ultrasonic signal, measurement microphone 72 may capture the audio signal, e.g., test tone, modulating the ultrasonic carrier signal. The resulting electrical signal may be run through an analog-to-digital (A/D) converter to digitize the signal for analysis. The Fourier transform of the test tone is the frequency response, and thus, by capturing the test tone data, the frequency response of emitter 6 can be determined.

In accordance with one embodiment, acoustic filter 71 may comprise a thin film material, such as Mylar, Kapton, Polypropylene, polycarbonate, Aluminum/Polyimide film, Melinex, Hostaphan or other like materials. It should be noted that other thin film-like materials may be used. Additional examples of materials include, but are not limited to: plastic, metallic materials, nanotube sheets, graphene, and still other films such as even liquid-based films so long as they can be supported appropriately. In accordance with some embodiments, thinner and lighter materials may be more optimal, as will be described below.

In accordance with one embodiment, where Mylar is utilized for acoustic filter 71, the Mylar may be, e.g., 1 mil thick. Using a 1 mil thick Mylar film, acoustic filter 71 can be completely passive up to approximately 10 kHz. That is, audio signals up to 10 kHz can pass through acoustic filter 71. Thinner Mylar, for example, ¼mil thick Mylar film may be utilized in accordance with another embodiment for passage of audio signals up to, e.g., 11 kHz, and so on. It should be noted that thicker Mylar film may be utilized as well, although thicker materials will typically exhibit a lower cutoff frequency and may begin to affect passage of the audio signals as well as that of the ultrasonic carrier signal. Accordingly, the thickness of material utilized in acoustic filter 71 can be varied based upon a desired level of filtering and cut off frequency, the audio signal to be received, etc.

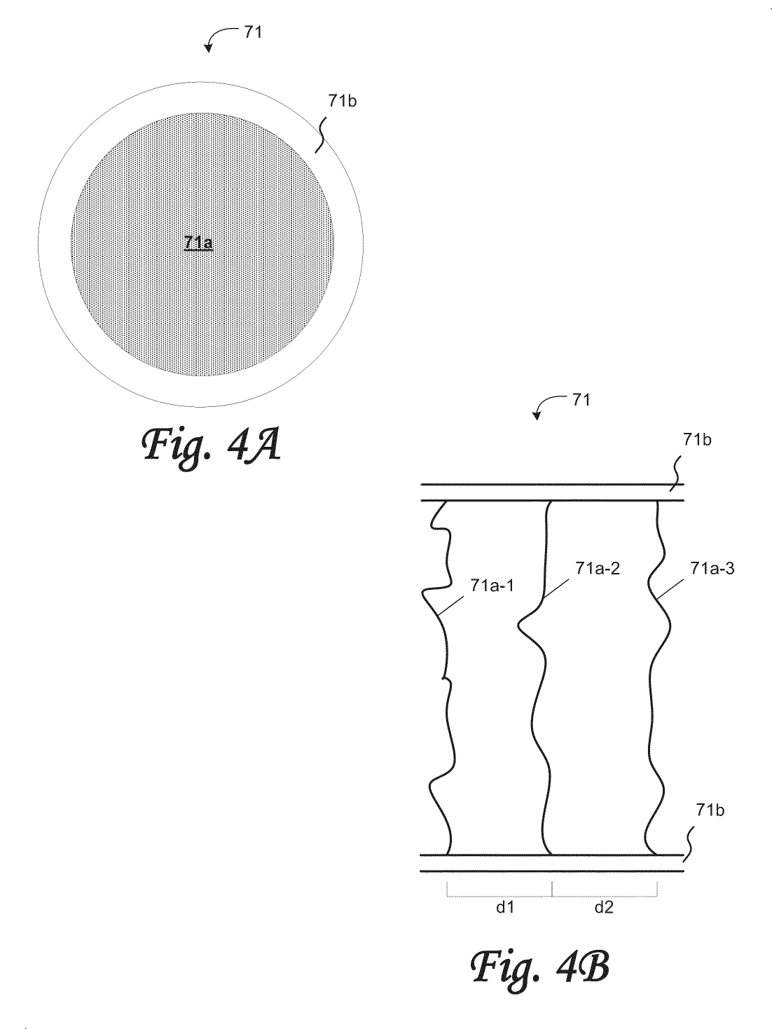

FIG. 4A illustrates a frontal view of acoustic filter 71. Acoustic filter 71 may include a film 71a, such as the aforementioned Mylar film, stretched over or within, or otherwise supported by a frame 71b. In accordance with one embodiment, film 71a may have a crinkled, crimped, creased, scalloped, textured, or otherwise non-smooth surface. The effect of configuring film 71a to have a non-smooth surface is that the reflection of ultrasonic sound waves directly back to emitter 6 (which could, for example, complicate any measurement calculations) is prevented or at least substantially lessened. Moreover, and in accordance with another embodiment, acoustic filter 71 may be tilted relative to one or more of measurement microphone 72 and the ultrasonic emitter being tested/measured to further assist in avoiding direct reflections back to the ultrasonic emitter. Likewise, it may be tented or otherwise faceted to avoid direct reflections. However, and in accordance with other embodiments, film 71a may be configured to have a substantially smooth surface, where any measurement calculations can be made taking into account the effects of the reflected ultrasound impinging on the ultrasonic emitter.

It should be noted that although acoustic filter 71 is illustrated as having a substantially circular shape, acoustic filter 71 can have any conceivable shape, e.g., square, rectangular, etc. Moreover, acoustic filter 71 can be configured to be a variety of sizes, although it is preferable that acoustic filter 71 not substantially surround or encapsulate microphone 72. Doing so, may create, e.g., a resonant cavity about measurement microphone 72 which, again, could complicate or otherwise skew any resulting measurements based upon the audio signal(s) received by measurement microphone 72.

FIG. 4B is a cross-sectional view of another embodiment of acoustic filter 71. In this embodiment, acoustic filter 71 may comprise multiple layers of Mylar film. In this example, three layers are shown, e.g., a first layer 71a-1, a second layer 71a-2, and a third layer 71a-3, although other quantities of layers can be provided. The thickness of these layers may be the same or different in accordance with certain embodiments depending on the desired level/type of filtering. The use of multiple layers of Mylar film may be applied to situations where more aggressive filtering is desired. For example, a listening environment may include multiple ultrasonic emitters and/or other sources of ultrasound, e.g., sensors, or other types of noise, the filtering of which would be beneficial to operation of or measurements based on audio signals received by microphone 72.

The distances d1, d2 between layers 71a-1, 71a-2, and 71a-3 may be some fraction of the wavelength of interest, i.e., that of the ultrasonic carrier wave. That is, thicknesses of layers 71a-1, 71a-2, and 71a-3, as well as the respective distances d1, d2there between may be selected to achieve cancellation of the ultrasonic carrier signal by way of destructive interference. In accordance with one embodiment, distances d1 and d2 may be 1/4 of the wavelength of the ultrasonic carrier signal. In accordance with another embodiment, distances d1 and d2 may be 1/2 of the wavelength of the ultrasonic carrier signal.

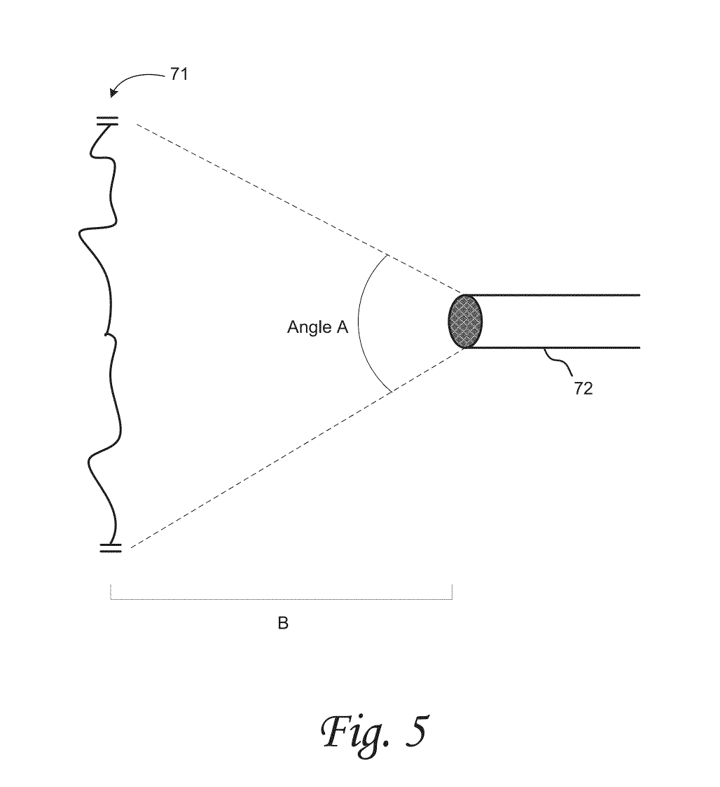

Still other aspects of various embodiments of the technology described herein relate to the distance between measurement microphone 72 and acoustic filter 71, as well as to the amount of physical ‘coverage’ provided by acoustic filter 71 relative to measurement microphone 72. FIG. 5 illustrates a side view of the relative positioning between measurement microphone 72 and acoustic filter 71 in accordance with one embodiment. In this embodiment, acoustic filter 71 may be located a distance B that is approximately 1 to 2 inches from the diaphragm of measurement microphone 72. Additionally, the angle (angle A) between the outer edge of the diaphragm of measurement microphone 72 and the outer edge of acoustic filter 71 may be approximately 45 degrees. It should also be understood that distance B and angle A may be inter-related, i.e., as the distance B between measurement microphone 72 and acoustic filter 71 is lessened or increased, the greater or lesser, respectively, the angle A between the outer edges of measurement microphone 72 and acoustic filter 71 becomes.

It should noted that at a minimum, angle A should be greater than approximately 10 degrees to avoid sound wave leakage/seepage around acoustic filter 71, and distance B should be no less than approximately 1 cm. For example, positioning acoustic filter 71 too close to measurement microphone 72 can result in an ultrasonic resonant cavity (ultrasound wavelengths are <10 mm). Moreover, at equal to or double the wavelength, gain may be added (which can be undesirable). However, at approximately 3×the wavelength and larger, the resulting cavity is not nearly as constructive and becomes largely irrelevant. Additionally, while there need not necessarily be any maximum limit upon the size of acoustic filter 71, the larger acoustic filter 71 becomes, consideration should be given to the introduction of complications associated with the potential for acoustic mode/drum-like effects on acoustic filter 71.

A third alternative becomes possible for applications in which the output from the loudspeaker is captured as a digital signal. Once the acoustic signal from the speaker has been digitized, it can be analyzed mathematically. Consider an example in which an impulse is fed into the loudspeaker. The Fourier transform of the impulse is the frequency response, a sum that can be computed relatively easily using a processing module. Therefore, in embodiments the capture the impulse data, the frequency response of the loudspeaker can be determined. In some embodiments, the system can be configured to determine which part of the impulse to transform. By deliberately truncating the ‘tail’ of the impulse, the calculation can effectively cut off the reflections since these arrive at the measurement microphone later than the direct sound. The reflections are removed by a window in time.

Although various embodiments have been described above in the context of measurement systems, use of acoustic filters as described herein can be applied to other scenarios. For example, active noise cancellation through the use of ultrasound may involve obtaining feedback about audio transmission and what is actually being heard by one or more listeners. Accordingly, acoustic filters such as those described above may be used in conjunction with measurement microphones in order to ascertain that feedback. Additionally still, the ultrasonic emitters described herein can be adjusted to compensate for ambient noise, by altering the gain of the amplifier. Accordingly, and again, the acoustic filter described herein can be utilized to provide accurate measurements/information regarding the ambient noise.

While various embodiments have been described above, it should be understood that they have been presented by way of example only, and not of limitation. Likewise, the various diagrams may depict an example architectural or other configuration, which is done to aid in understanding the features and functionality that can be included in various embodiments. The technology disclosed herein is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. In addition, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the technology disclosed herein is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A measurement system, comprising:
a microphone;
an acoustic filter disposed intermediate to a diaphragm of the microphone and an ultrasonic emitter, the acoustic filter being configured to filter at least one ultrasound signal component from an audio modulated ultrasonic signal launched by the ultrasonic emitter such that substantially only an audio signal produced in the air between the ultrasonic emitter and acoustic filter is transmitted to the diaphragm of the microphone;
a preamplifier adapted to receive the audio signal from the microphone and prepare the audio signal for processing; and
a measurement application configured to analyze the audio signal to determine a frequency response of the ultrasonic emitter.

2. The measurement system of claim 1, wherein the acoustic filter comprises at least one layer of material supported by a frame, the at least one film of material adapted to absorb or reflect the at least one ultrasound signal component.

3. The measurement system of claim 2, wherein the at least one layer of material comprises a film of Mylar that is at least ¼mil thick.

4. The measurement system of claim 2, wherein the at least one layer of material has a non-smooth surface configured to direct reflection of the at least one ultrasound signal component in directions other than toward the ultrasonic emitter.

5. The measurement system of claim 1, wherein the acoustic filter comprises a plurality of layers of material supported by a frame, the plurality of layers of material adapted to absorb or reflect the at least one ultrasound signal component.

6. The measurement system of claim 5, wherein the plurality of layers of material are spaced at a distance equivalent to a fraction of a wavelength of the at least one ultrasound signal component.

7. The measurement system of claim 6, wherein the spacing of the plurality of layers of material allow for cancellation of the at least one ultrasound signal component via destructive interference.

8. The measurement system of claim 1, wherein the acoustic filter is positioned at least 1 cm from the microphone.

9. The measurement system of claim 1, wherein the acoustic filter is positioned relative to the microphone such that an angle of coverage defined by an outer edge of the diaphragm of the microphone and an outer edge of the acoustic filter is at least 10 degrees.

10. A measurement microphone system, comprising:
a measurement microphone configured to be coupled to a measurement device; and
an acoustic low pass filter comprising at least one layer of film disposed intermediate to a diaphragm of the measurement microphone and an ultrasonic emitter, the acoustic low pass filter being configured to filter an ultrasound signal from an audio modulated ultrasonic signal launched by the ultrasonic emitter while allowing a portion of audio demodulated from the modulated ultrasonic signal to pass through the acoustic low pass filter and to the diaphragm of the microphone such that the portion of the audio demodulated from the modulated ultrasonic signal that passes through the acoustic low pass filter is detectable by the measurement microphone at a sufficient level to permit an intended measurement by the measurement device.

11. The measurement microphone system of claim 10, wherein the at least one layer of film has a thickness of approximately ¼mil, and wherein the at least one layer of film has a substantially non-smooth surface configured to prevent direct reflection of the ultrasound signal back to the ultrasonic emitter.

12. The measurement microphone system of claim 10, wherein the acoustic low pass filter further comprises additional layers of film, each of the layers of film are spaced at a distance equivalent to a fraction of the wavelength of the ultrasound signal or at frequency near the ultrasound signal.

13. The measurement microphone system of claim 10, wherein the acoustic low pass filter is positioned at least 1 cm from the measurement microphone.

14. The measurement microphone system of claim 10, wherein the acoustic low pass filter is positioned relative to the measurement microphone such that an angle of coverage defined by an outer edge of the diaphragm of the measurement microphone and an outer edge of the low pass acoustic filter is at least 10 degrees.

15. The measurement microphone system of claim 10, wherein the acoustic low pass filter filters at least 15 dB of the ultrasound signal.

16. An ultrasonic acoustic filter, comprising:
a film; and
a frame configured to substantially support the film in a position intermediate to a diaphragm of a microphone and an ultrasonic emitter, the film being configured to filter an ultrasonic portion of a modulated ultrasonic signal launched by the ultrasonic emitter while allowing a portion of audio signal demodulated from the modulated ultrasonic signal to pass through the filter and to the diaphragm of the microphone.

17. The ultrasonic acoustic filter of claim 16, wherein the film is approximately 1 mil thick.

18. The ultrasonic acoustic filter of claim 16, wherein the film has a textured surface to reflect at least a portion of the ultrasonic signal away from the ultrasonic emitter.

19. The ultrasonic acoustic filter of claim 16, further comprising a plurality of additional layers of Mylar film placed adjacent to the Mylar film and spaced at distances equivalent to a fraction of the wavelength of the ultrasonic portion of the modulated ultrasonic signal or a frequency near that of the ultrasonic portion of the modulated ultrasonic signal.

20. The ultrasonic acoustic filter of claim 16, wherein the frame is positioned at least 1 cm from the diaphragm of the microphone.

21. The ultrasonic acoustic filter of claim 16, wherein the diaphragm of the microphone is positioned relative to the ultrasonic acoustic filter such that an angle of coverage defined by an outer edge of the diaphragm of the microphone and an outer edge of the ultrasonic acoustic filter is at least 10 degrees.
